(19) United States
(12) Patent Application Publication
(10) Pub. No.: US 2016/0012522 A1
(43) Pub. Date: Jan. 14, 2016

(54) SYSTEM AND METHOD OF AUTOMATIC ARBITRATION IN VEHICLE TRADING

(71) Applicant: NthGen Software Inc., Toronto (CA)

(72) Inventors: Mark Endras, Toronto (CA); Hon-Wai Chia, Toronto (CA)

(73) Assignee: NthGen Software Inc.

(21) Appl. No.: 14/794,571

(22) Filed: Jul. 8, 2015

Related U.S. Application Data
(60) Provisional application No. 62/022,146, filed on Jul. 8, 2014.

(51) Int. Cl. G06Q 30/08; G06Q 10/00; G06Q 30/06

(52) U.S. Cl. CPC G06Q 30/08; G06Q 30/0613; G06Q 10/20

(57) ABSTRACT

Following an online auction of a vehicle, a buyer can file a report of a disputed feature. This report includes a descriptive component and a photo or video component. The buyer also submits a desired compensation for the disputed feature. An automatic settlement is arrived at based on a selection and calculation from one of: the buyer's desired compensation, a difference between the assessed value of the vehicle and the price paid, and an estimate to repair or replace the disputed feature. Automatic funds settlement may follow the buyer's acceptance of the automatic settlement.

### CROSS-REFERENCE TO RELATED APPLICATIONS

This application claims the benefit of U.S. Provisional Patent Application No. 62/022,146 filed Jul. 8, 2014, entitled System and Method of Automatic Arbitration in Vehicle Trading, which is incorporated herein by reference in its entirety.

### FIELD OF INVENTION

The field of invention is generally related to e-commerce and in particular is related to automated methods of arbitration when dealing with disputes in vehicle trading especially online vehicle auctions.

### BACKGROUND

Historically barter, haggling, sale by a set-price and auctions have been some of the traditional ways to negotiate the exchange of goods and commodities. An auction is a process of buying and selling goods or services by offering them up for bid, taking bids, and then selling the item to the highest bidder. Bidding is the act of participating in an auction by offering to purchase an item for sale. Prices are bid by buyers and asked (or offered) by sellers. Auctions are publicly and privately seen in several contexts and almost anything can be sold at an auction. E-Bidding or Electronic Bidding—is a type of auction, whereby a person may make a bid without being physically present at an auction or where the entire auction is taking place on the Internet.

Online auctions for vehicles are common where a wide variety of off-lease, commercial and dealer vehicles may be sold to other dealers and the public. Some dealers may auction one or more vehicles to other dealers who in turn sell these to the public via their showrooms.

Online auctions are prone to manipulation since in an online auction a vehicle may be remote, where only digital representation e.g. photos and videos are available to bidders. Thus it is easy to hide blemishes or other kinds of damage from prospective bidders, for example if a vehicle has a cracked windshield or worn out tires. Additionally digital data can be manipulated e.g. photos can be edited using software like Photoshop. Thus when the buyer gets the vehicle it may not meet their expectations which were based on digital representations which were different from the actual vehicle.

Such discrepancies can give rise to disputes and such cases often lead to arbitration before the buyer can either return the vehicle to the seller for a full refund or be compensated by a dollar amount to cover the disputed feature.

Arbitration is a technique for the resolution of disputes outside of the courts. A third party reviews the evidence in the case and imposes a decision that is legally binding on both sides and enforceable in the courts. Arbitration is often used for the resolution of commercial disputes. Arbitration is also frequently employed in consumer and employment matters, where arbitration may be mandated by the terms of commercial contracts. Arbitration is a proceeding in which a dispute is resolved by an impartial adjudicator whose decision the parties to the dispute have agreed will be final and binding. In certain contexts, such procedures are preferable to resolving disputes in court. However, human arbitration can be expensive, time consuming and disruptive to the business of online vehicle auctions.

It would be desirable to have an automated arbitration system suited to online vehicle auctions that offers a fast, timely, impartial, simplified, data based, and cost effective way to resolve disputes.

### SUMMARY

Briefly stated, the present invention relates to a system and method of automatic arbitration in vehicle auctions, which allows for the resolution of disputes in a timely and impartial way. The system may run on a server that is accessible to users preferably via connected mobile devices.

For example, there may be an application using which a user may interact with the functionality provided by the system. The application may be specific for a particular mobile device e.g. an iPhone or a Google Android phone, or a tablet computer etc. or generic e.g. Flash or HTML5 based app that can be used in a browser.

Users may use connected devices e.g. a Smartphone, a tablet, or a personal computer to connect with the system e.g. using a browser on a personal computer to access the website or via an app on a mobile device. For example, users may download the app from an AppStore. Devices where invention can be advantageously used may include but not limited to an iPhone, iPad, Smartphones, Android phones, personal computers e.g. laptops, tablet computers, touch-screen computers running any number of different operating systems e.g. MS Windows, Apple iOS, Linux, Ubuntu, etc.

According to an aspect of the invention, a method is provided for computer-mediated arbitration following an online auction of a vehicle between a seller and a buyer. The seller and the buyer have consented to automatic arbitration of disputes related to the auction. The buyer has received and inspected the vehicle following the auction. A vehicle identification number of the vehicle is received or retrieved. A price paid in the auction is received or retrieved. A report is received from the buyer with respect to a disputed feature. The report preferably includes a descriptive component and a photo or video component. A desired compensation is also received from the buyer. A threshold assessment is made from the report as to whether a dispute is present. (The assessment may also verify the information entered by the buyer against an Arbitration Rule Set.) If a dispute is present, this is communicated to the seller. An assessment of a vehicle value based on the vehicle identification number is received or retrieved. The report is used to calculate or look up an estimate to repair or replace the disputed feature. The system selects a lowest one of the following values: the buyer's desired compensation, (the assessed vehicle value less the price paid), and the repair estimate. From the selected lowest value, a first settlement amount is calculated. The first settlement amount is communicated to the buyer. If the first settlement amount is accepted by the buyer, the settlement is communicated to the seller, and funds settlement at the seller's and buyer's auction accounts is automatically initiated.

In one embodiment, the first settlement amount is a percentage of the selected value (e.g. 85% of the lowest value).

Preferably, the repair estimate is an estimated or actual cost to repair or replace the disputed feature of the vehicle. The repair estimate may be derived from realtime repair transactional data, industry accepted repair estimates, crowdsourced repair data, or a repair estimate submitted by the buyer (or some function or average of these amounts).

In some embodiments, the vehicle identification number is entered using at least one of a barcode scanner, digital camera, on board diagnostics, or user input.

The vehicle value assessment may be done using data retrieved by querying the vehicle identification number in a third party database. Such an assessment may be retrieved from an assessment done during or before the auction (for example, to support or validate the auction price).

The vehicle identification number and the price paid may also be retrieved from the auction.

In certain embodiments, the first settlement offer may have an expiry date or time.

If the first settlement offer is not accepted or expires, a second settlement offer may be communicated to the buyer. This may be repeated until an offer is accepted, or a threshold (e.g. maximum or minimum) offer amount is reached, or a maximum time has elapsed.

The threshold assessment may include an assessment of past auction or dispute behaviour or a ranking or a rating of at least one of the buyer and the seller.

The vehicle value assessment may include:
retrieving a universe of historical pricing data of vehicles having a common at least one parameter with the vehicle, and from the universe of historical pricing data, establishing a maximum potential wholesale value;
retrieving data regarding the vehicle and its condition (e.g. by exploding the VIN) and converting the data into at least one modifier; and
reducing the maximum potential wholesale value by the at least one modifier.

The assessment may include querying at least one third party database.

The descriptive component of the report may be submitted using text, voice, or another verbal medium.

In some embodiments, the threshold assessment may occur after the selecting step but before the communicating step.

If it is determined that there is no dispute then the buyer may be informed that there is no dispute.

If it is determined that there is a dispute then both the buyer and the seller may be informed that there is a dispute; and the notice may also include information about the vehicle, the disputed feature(s) and the desired compensation.

In one embodiment an electronic message containing this information may be sent to the users via the app. If a user does not have the app installed on their mobile device, the message may be sent in an e-mail preferably along with a link to download the app. In other embodiments the electronic message may also be presented to the user via an e-mail, a text message, a voice mail, a link being added to the homepage on a social media website e.g. Facebook homepage.

In certain embodiments the assessed value (AV) of the vehicle may be compared with the price paid (PP) by the buyer for the said vehicle. If the difference between the assessed value (AV) and the price paid (PP) by the buyer (AV−PP) is greater than the RE (repair estimate) of the disputed feature(s) of the said vehicle then it is possible that there is no dispute as the lower price paid by the buyer takes into consideration the broken or faulty status of the disputed feature. While if the difference between assessed value (AV) and the price paid (PP) by the buyer (AV−PP) is smaller than RE (repair estimate) of the disputed feature(s) of the said vehicle then it is possible that there is a dispute as the buyer paid more for the vehicle and the higher price does not take into consideration the discount due to the broken or faulty status of the disputed feature.

In one embodiment the lowest amount may be identified amongst desired compensation (DC), (AV−PP) and repair estimate (RE). In one embodiment the lowest amount can be determined by putting these three values in an ascending order and the first value then being identified as the lowest. The first settlement offer may be calculated as a percentage of the lowest amount e.g. 85% of the lowest value.

In one embodiment the debit/credit of accounts may be asynchronous and non-realtime as it may take a given amount of time to clear funds. In another embodiment the debit/credit of accounts may be instantaneous and synchronous.

### BRIEF DESCRIPTION OF THE FIGURES

FIG. 1 is a flow diagram illustrating a basic method of automatic vehicle auction arbitration according to a preferred embodiment of the invention.

FIG. 2 is a flow diagram illustrating the calculation and settlement steps of the method.

FIG. 3 is a flow diagram illustrating potential aspects of the report submitted by the buyer.

FIG. 4 is a flow diagram illustrating potential aspects of the buyer's desired compensation.

FIG. 5 is a flow diagram illustrating potential sources or aspects of the estimate calculation or lookup.

FIG. 6 is a flow diagram illustrating a potential process for determination of the estimate.

FIG. 7 is a flow diagram illustrating comparison between the (AV−PP) value and RE value.

FIG. 8 is a flow diagram illustrating potential vehicle value assessment based on a VIN.

FIG. 9 is a flow diagram illustrating comparison between (AV−PP) value, RE value, and DC submitted by the buyer.

### DETAILED DESCRIPTION

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements. However, in at least one embodiment, the components comprised in the method and tools are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

In order to provide a context for the various aspects of the disclosed invention, as well as the following discussion are intended to provide a brief, general description of a suitable environment in which the various aspects of the disclosed invention may be implemented. While the invention has been described in the general context of computer-executable instructions of a program that runs on one or more computers, the invention also may be implemented in combination with other program modules. Generally, program modules include routines, programs, components, data structures, etc. that perform particular tasks and/or implement particular abstract data types. Moreover, the system and method may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch or other electronic gadgets incorporating the capacity to compute), microprocessor-based or programmable consumer or industrial electronics, and the like. The illustrated aspects may also be practiced in distributed computing environments where tasks/routines/processes etc. are performed by remote processing devices that are linked through a communications network e.g. a local area network (LAN) or the Internet. However, some, if not all aspects may be practiced on stand-alone computer(s). In a distributed computing environment, program modules may be located in both local and remote memory storage devices.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. Some embodiments may use well-known open-source Web development platforms using Linux, Apache, MySQL and PHP. Other examples of environments and frameworks using which computer code may also be generated are Ruby on Rails which is based on the Ruby programming language, or node.js which is an event-driven server-side JavaScript environment.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The code is specialized to execute the functions described herein which enable a smoother and more efficient technological process.

Computing devices that enable a user to engage with internet in general may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a USB memory key, flash memory, or other type of memory media all collectively referred to as “removable media” in this disclosure. The app may also be downloaded from the internet. The removable media can be inserted to the console of a computing device where it is read. The console can then read program instructions stored on the removable media and present a user interface to the user. The user interface may preferably be a graphical user interface (GUI). Example of such computing devices are personal computers e.g. a laptop or a Mac, a Smartphone, a tablet, a SmartTV, etc.

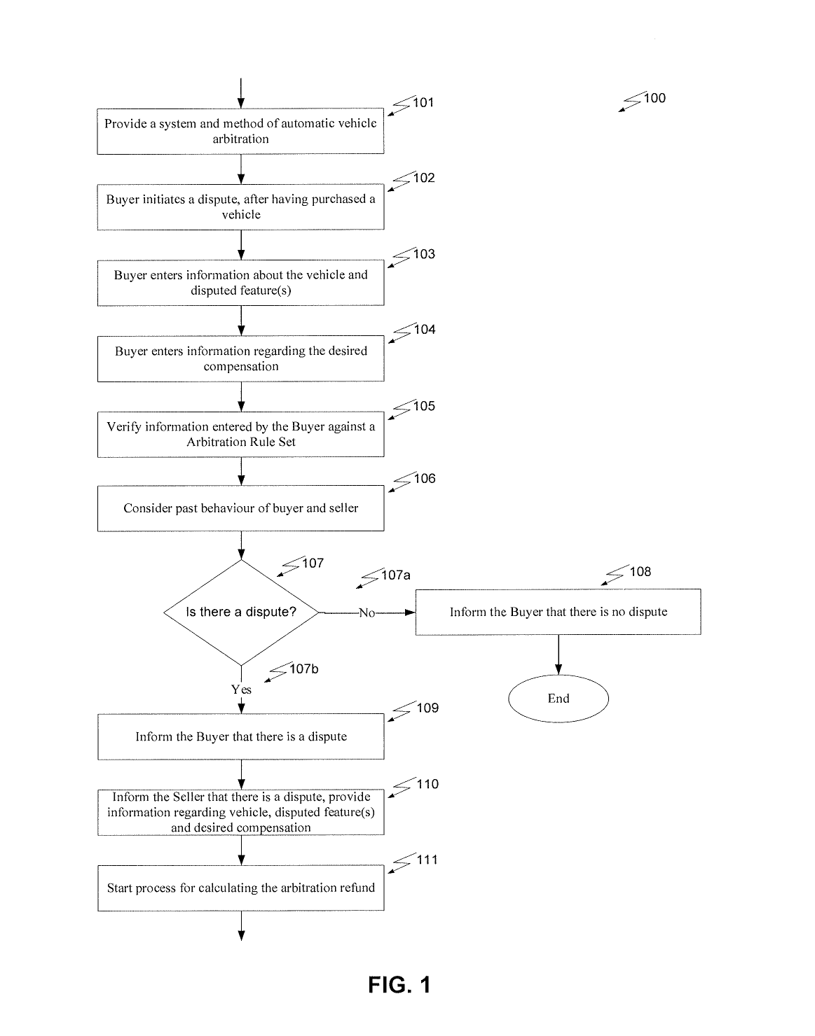

FIG. 1 shows one embodiment of the present method 100. A system and method is provided for automatic vehicle arbitration that can preferably be used in vehicle auctions 101.

The system may run on a server that is accessible to users e.g. buyers, sellers and bidders over a network for example the internet. In one embodiment sellers can start an auction while bidders participate in the auction by placing bids on the vehicle being auctioned by the sellers. A successful bidder is deemed to be the buyer of the vehicle.

Preferably the users may connect to the system using a connected device e.g. a Smartphone, a tablet, or a personal computer e.g. using a browser on a personal computer to access the website or via an app on a mobile device. In one embodiment the app may be downloaded from an AppStore.

In the preferred embodiment the system and method may be implemented on a server such that it is accessible over the Internet through a computing device, e.g. a browser on a personal computer or a browser on a mobile device like a Smartphone, a tablet or the like. Devices where the invention can be advantageously used include but are not limited to personal computers e.g. laptops, tablet computers, touch-screen computers running any number of different operating systems e.g. MS Windows, Apple iOS, Linux, Ubuntu, etc., Smartphones like an iPhone, an Android phone, tablets like iPad and the like.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. Instructions for performing different functions may be included in a computer readable storage medium or other computer program product configured for execution by one or more processors.

The buyer may initiate a dispute after having purchased and receiving the vehicle 102. Many factors may influence the value of a vehicle. If vehicle has been misrepresented by hiding a blemish in a digital representation (photo or video), then there are chances that a buyer may have over paid for the said vehicle. If the buyer is not satisfied when he receives the said vehicle he may initiate a dispute.

The buyer enters information about the vehicle and the disputed feature(s) 103. In one embodiment some or all of the information regarding the vehicle may already be present in the system as the vehicle was auctioned over the system; in such cases the buyer enters the information about the disputed feature(s).

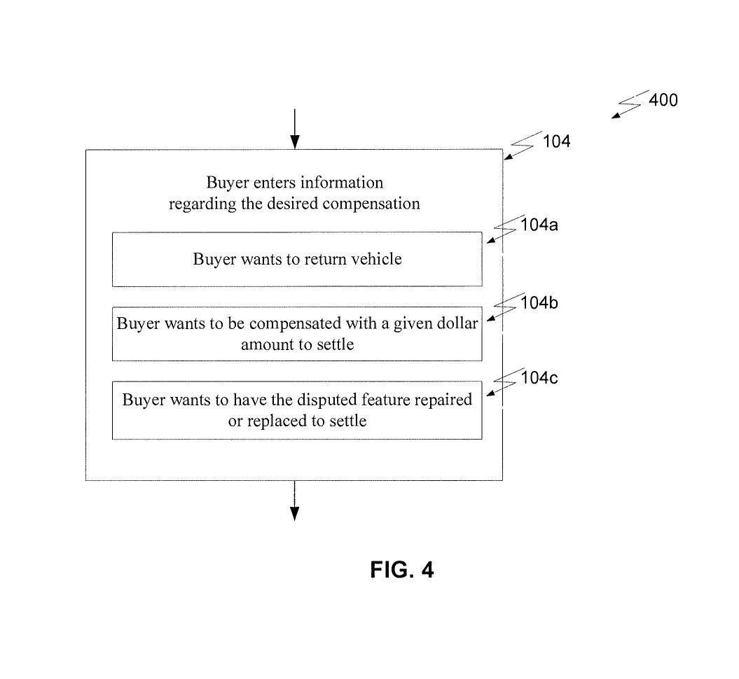

The buyer enters information about the desired compensation (e.g. type and amount) 104. In one embodiment the buyer enters the details of the desired compensation. In one embodiment the buyer may wish to either return the vehicle or have the seller repair or replace the faulty part or be compensated a certain lump sum. This process is explained in further detail below with respect FIG. 4.

The information entered by the buyer is preferably verified against an Arbitration Rule Set 105. The Arbitration Rule Set may be used to enable the parties to a dispute to achieve a just, speedy and cost effective determination of matters in dispute, taking into account the values that distinguish arbitration from litigation. For example, there may be national or federal rules, state or province wide rules or system defined rules for initiating arbitration. In one embodiment the system defined rules also take the local rules into consideration and add some further refinements to them. In some embodiments one Arbitration Rule Set may be flexibly replaced or substituted with another Arbitration Rule Set depending on the location of the buyer or situation or complexity of the dispute. In other embodiments, the buyer and seller may be allowed to specify, modify or customize the Rule Set in advance of the auction (or before closing the sale following the auction), and/or may consent to a Rule Set specified at the auction site.

Past behaviour of the buyer and seller may be considered 106. If the system has past information about the buyer and the seller and the vehicles that they have purchased and sold, such past history may be considered, and any disputes/arbitrations in the past may be identified and the outcome of these disputes/arbitrations may be determined and evaluated.

The system may then evaluate whether there is a dispute for resolution at all 107. In one embodiment if it is determined that there is no dispute (e.g. no basis for dispute in what was submitted, or the amount is too minimal, or something in the history of the parties or the dispute makes the report unreliable) 107a then the system informs the buyer that there is no dispute 108. In one embodiment an electronic message containing this information may be sent to the buyer via the app. If a buyer does not have the app installed on their mobile device, the message may be sent in an e-mail preferably along with a link to download the app. In other embodiments the electronic message may also be presented to the buyer via an e-mail, a text message, a voice mail, a link being added to the homepage on a social media website e.g. Facebook homepage.

If it is determined that there is a dispute 107b then the system informs the buyer that there is a dispute 109. In one embodiment an electronic message containing this information may be sent to the buyer via the app. If a buyer does not have the app installed on their mobile device, the message may be sent in an e-mail preferably along with a link to download the app. In other embodiments the electronic message may also be presented to the buyer via an e-mail, a text message, a voice mail, a link being added to the homepage on a social media website e.g. Facebook homepage.

The seller may be informed that there is a dispute; and information may be provided about the vehicle, the disputed feature(s) and the desired compensation 110. In one embodiment an electronic message containing this information may be sent to the seller along with the information about the vehicle via the app. If a seller does not have the app installed on their mobile device, the message may be sent in an e-mail preferably along with a link to download the app. In other embodiments the electronic message may also be presented to the seller via an e-mail, a text message, a voice mail, a link being added to the homepage on a social media website e.g. Facebook homepage.

The system may then begin the process of the calculating the settlement (arbitration) refund to be offered to the buyer 111.

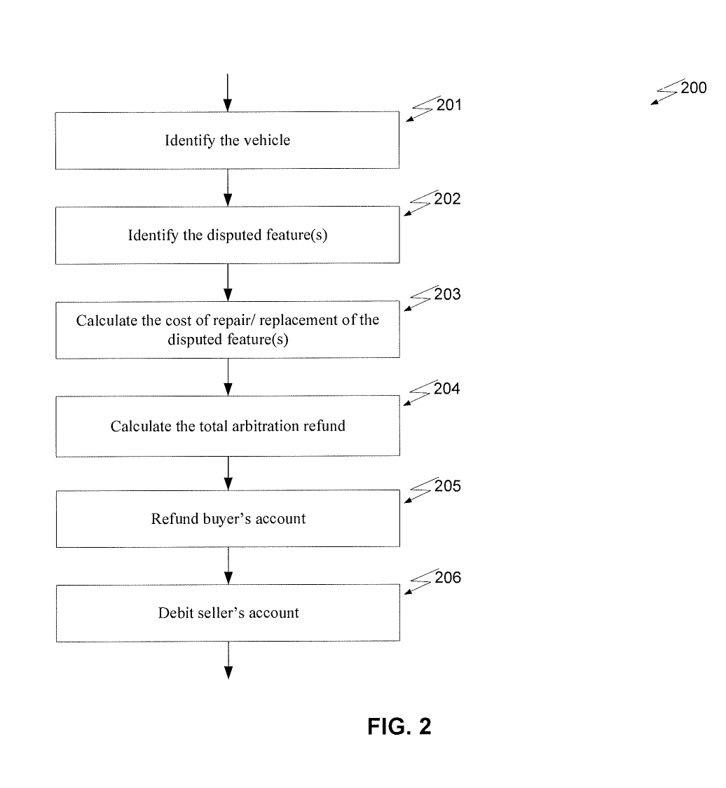

FIG. 2 shows one embodiment 200. The vehicle is identified 201. This may include acquiring its VIN. A VIN (Vehicle Identification Number) is a unique code, including a serial number, used by the automotive industry to identify individual motor vehicles. VIN is an evolving standard and may change in the future depending on the needs of the industry. The first three characters uniquely identify the manufacturer of the vehicle using the world manufacturer identifier or VIN code. There are 17 numbers and letters (17 positions) in a VIN and these can be divided into three groups: World Manufacturer Identifier, Vehicle Descriptor Section, and Vehicle Identifier Section.

In one embodiment the VIN may already be available in the system as the vehicle was auctioned using the system. In another embodiment if the VIN is not available in the system, it may be inputted by the buyer by physically reading it from the vehicle. Such an embodiment may provide a user interface for inputting the VIN. User input may also be provided via text or voice or other methods.

In one embodiment, the VIN may be “exploded” which implies decoding the information that is contained in the VIN. This information may be used to get further information about the vehicle from third parties. A VIN can be decoded using third party services.

The vehicle information that may be acquired from third parties by using the VIN may include but is not limited to a vehicle's make, model, year, installed options, mileage, color, region where the vehicle is from, vehicle ownership history, accident history etc. The aforementioned list of vehicle information is exemplary and in other implementations different information or information sets may be obtained from third parties. The invention is not limited to these examples but the intent is to cover all such information that may be obtained using the VIN.

The disputed feature(s) are identified 202. In one embodiment the disputed feature has been inputted by the buyer, e.g. the buyer may have inputted that the windscreen is cracked.

The cost of repair/replacement of the disputed feature(s) is calculated 203. For example, the system may calculate the cost of replacing a windscreen for a vehicle with the given make, model and year that the buyer has purchased.

There are well defined dollar figures (or well defined ranges of dollar figures) that can be used to determine the estimate cost when a particular element (tires, windscreen, dent, broken taillight or headlight, etc.) needs to be replaced, repaired, etc. For example if a vehicle has a broken headlight it can be quite accurately determined what it will cost to get a new genuine or aftermarket headlight for that particular vehicle.

A total settlement offer amount (arbitration refund) is calculated 204. For example, if there are more than one disputed features then these may be summed to calculate the total arbitration refund (i.e. consider all of a vehicle's disputed features and sum up the costs of each replacement or repair to determine the total arbitration refund).

The system may then proceed to refund the buyer's account 205. That is, the system can refund the buyer account with the total arbitration refund amount, if such information is available in the system and/or send an electronic message containing the arbitration refund to the buyer via the app. If a buyer does not have the app installed on their mobile device, the message may be sent in an e-mail preferably along with a link to download the app.

The system may then proceed to debit the seller's account (or the order with 205 may be reversed—debit then credit the refund) 206. That is, the system can debit the seller's account with the amount of the arbitration refund and send an electronic message containing the arbitration refund of the disputed vehicle to the seller via the preferred mode of communications e.g. an e-mail, a text message, a voice mail, a link being added to the homepage on a social media website e.g. Facebook homepage.

In certain embodiments the debit/credit of accounts may be asynchronous and non-realtime as it may take a given amount of time to clear funds. Alternatively, the debit/credit of accounts may be instantaneous and synchronous.

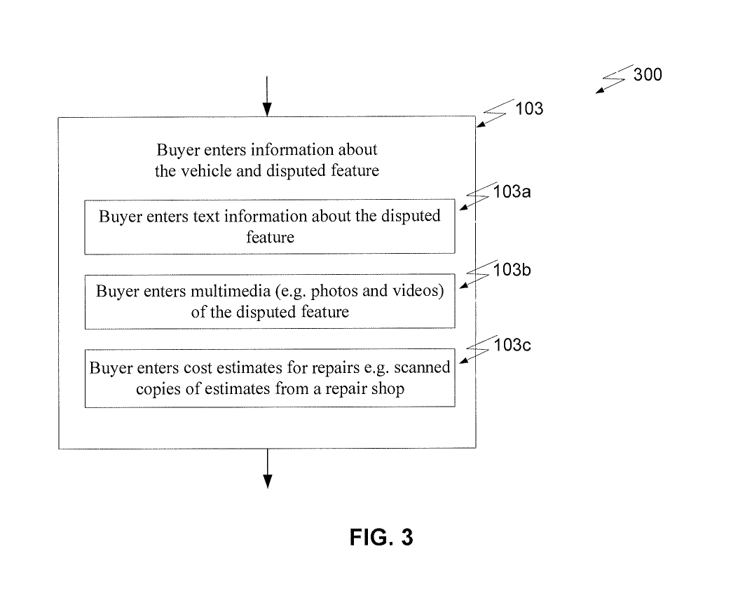

FIG. 3 shows one embodiment 300. The buyer enters information about the vehicle and the disputed feature(s) 103. In one embodiment the system may preferably provide a means for the buyer to input information about the vehicle and the disputed feature. Such information may be inputted by the buyer using a web based system utilizing a browser, or an app, or using voice commands or other input means.

The buyer can enter text information about the disputed feature(s) 103a. For example, the buyer may enter text based components of the information about the disputed feature(s) e.g. a description of the broken headlight.

The buyer can also enter multimedia information (e.g. photos and videos) about the disputed feature(s) 103b. For example, the buyer may enter multimedia components of the information about the disputed feature(s) e.g. the buyer takes a photo and video of the disputed feature like a broken headlight using the mobile device were an app may be installed.

The buyer can also enter cost estimates for repairs e.g. scanned estimates from a repair shop for the repair of the disputed feature(s) 103c. For example, the buyer may enter cost estimates that he may have gotten from a third party repair shop, to fix, repair or replace the disputed feature(s) e.g. the cost estimate to replace the broken headlight. (Alternatively, the system may have access to historical or crowdsourced or industry data for repair or replacement estimates.)

FIG. 4 shows one embodiment 400. The buyer can enter information regarding the desired compensation 104. The system may preferably provide a means for the buyer to input information about the desired compensation. Such information may be inputted by the buyer using a web based system utilizing a browser, or an app, or using voice commands or other input means.

The buyer may want to return the vehicle 104a. For example, the buyer may opt for returning the vehicle. In one embodiment there may be a drop down menu from which the buyer selects the appropriate choice of desired compensation. In another embodiment there may be radio buttons and the buyer may select a choice by putting a check mark on the appropriate choice.

The buyer may want to be compensated with a given dollar amount to settle 104b. For example, the buyer may enter a dollar amount that is desired as compensation to settle the dispute (i.e. not necessarily tied to any particular repair or replacement intent).

The buyer may want to have the disputed feature(s) repaired or replaced to settle 104c. For example, the buyer may choose to have the disputed feature(s) repaired or replaced to settle the dispute e.g. buyer wants the seller to have the broken headlight replaced. Such information may be inputted by the buyer using a web based system utilizing a browser, or an app, or using voice commands or other input means.

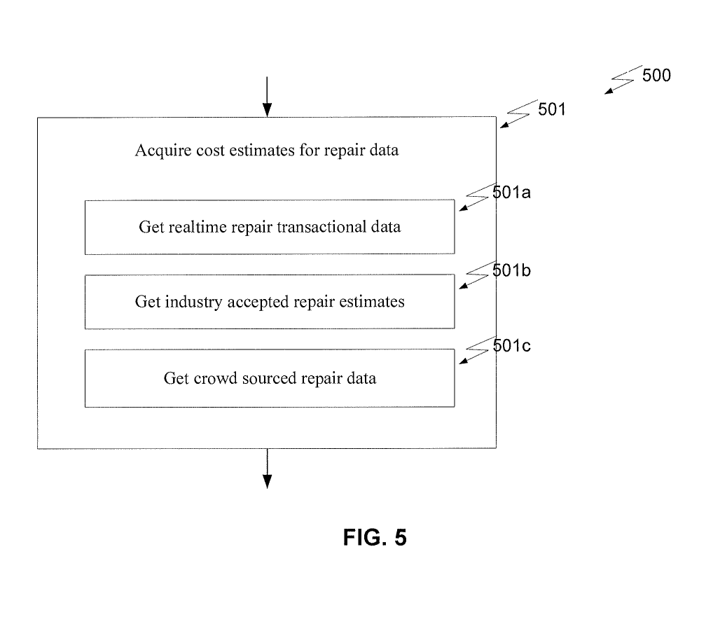

FIG. 5 shows one embodiment. Cost estimates may be acquired for repair data 500. In order to get the best estimates for repair costs information may be obtained from more than one sources, such sources may be internal e.g. data gathered over a period of time or such sources may be external and third party provided.

Sources may include realtime repair transactional data 500a. For example, the system may get realtime repair transactional data from third parties e.g. dealerships, repair workshops etc.

Sources may also include industry accepted repair estimates 500b. For example, the system may get industry accepted repair estimates from third parties.

Sources may also include crowd sourced repair data 500c. For example, the system may get crowd sourced repair cost data e.g. an interface may be provided using which scores of people (the “crowd”) may provide the actual cost of the repairs that they may have had on their vehicles. In order to verify the data added by the crowd, people may be asked to provide a scanned copy of the actual bills or receipts of the repair work they may have had performed on their vehicles.

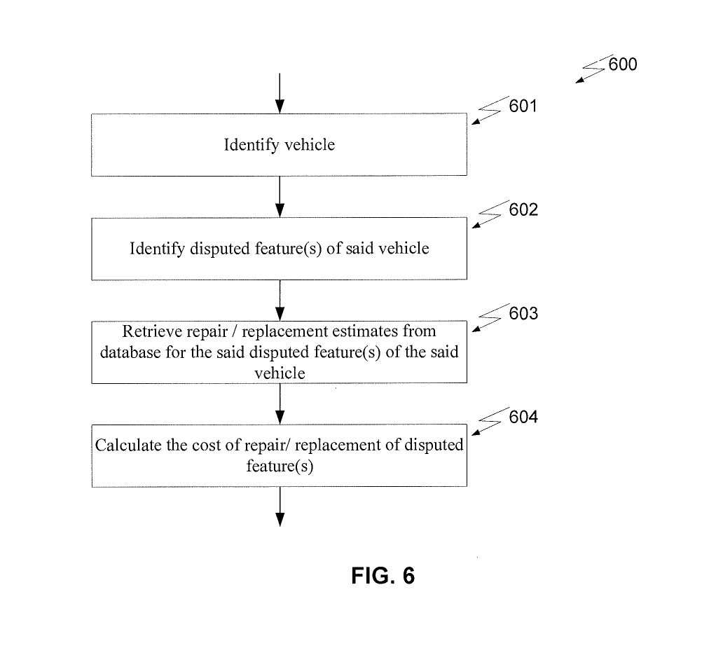

FIG. 6 shows one embodiment 600. The vehicle may first be identified 601. The vehicle may be uniquely identified using VIN.

The disputed feature(s) of the vehicle may also be identified 602. For example, the buyer may input any disputed features, e.g. the buyer may input that the tires are worn out and need replacement.

Repair/replacement estimates are retrieved from the database for the disputed feature(s) of the said vehicle 603. In one embodiment the system may store historical and crowd sourced repair and replacement cost that can be used to generate repair/replacement estimates. FIG. 5 shows some of the means for acquiring such information.

The cost of repair/replacement of disputed feature(s) is calculated 604. For example, the cost of repair or replacement of the disputed feature is calculated, e.g. by calculating the cost of replacing a windscreen for a vehicle with the given make, model and year that the buyer has purchased. For many such features, there may be well defined dollar figures (or a well defined ranges) that can be used to determine if that particular element (tires, windscreen, dent, broken taillight or headlight, etc.) needs to be replaced, repaired, etc. For example if a vehicle has a broken taillight it can be quite accurately determined what it will cost to get a new genuine or aftermarket taillight for that particular vehicle.

The cost estimates for repair/replacement of a vehicle's components are dependent on its make, model, year, mileage, installed options, the region where the vehicle had been used in the past, amongst other factors. There are defined industry estimates that can be used to determine the refund amount. For example if a vehicle has worn out tires, it can be quite accurately determined what it will cost to get new tires for that particular vehicle.

A specific dollar amount may be derived that will be required to repair or replace the disputed feature(s) e.g. if the tires on the vehicle are worn out and require replacement, determine the dollar amount that will be needed to get new tires.

The system and method may preferably use a database that contains the historical data on the repair/replacement cost of different components of different vehicles in a region, or a country or globally. The historical data for different makes and models of vehicles may be acquired from third parties or may accumulate in the system as more buyers and sellers interact with it.

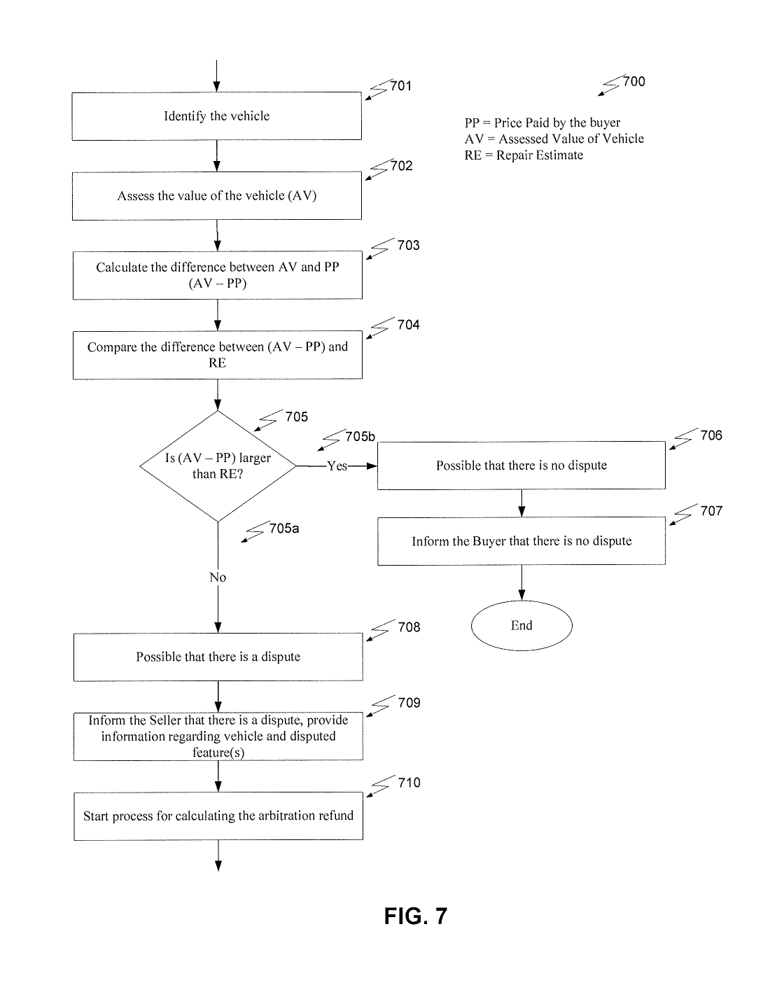

FIG. 7 shows one embodiment 700. The vehicle is identified 701. The vehicle may be uniquely identified using VIN.

The value of the vehicle is assessed 702. The assessed value of a vehicle is dependent on its make, model, year, mileage, installed options amongst other factors and the region where the vehicle had been used in the past. For example a vehicle with a given make, model, year that was driven in Los Angeles, Calif. may be assessed at a higher value than a similar vehicle with the same make, model and year that was driven in New York, N.Y. This difference in price may be due to worse winter conditions in NY and the use of salt on the roads in the winter which may make the vehicle's body prone to corrosion and rust.

Some exemplary factors that may be considered in the calculation of a vehicle's assessed value include, but are not limited to:
exterior condition
interior condition
condition of mechanical components
condition of tires
after market equipment
installed options
mileage
color

Major repairs to vehicle may reduce its assessed value, while normal maintenance performed at prescribed intervals such as oil changes, tune ups and replacement of belts and hoses etc. contribute positively in the assessment of the value of a vehicle. Major repairs to any of the following may reduce its assessed value:
engine
transmission
steering
brakes
suspension
exhaust system
electrical system
repainting of the vehicle

In one embodiment when calculating the assessed value of a vehicle additional information like its specific installed options; its condition e.g. any accidents, any dents, any paints jobs, any major or minor repairs etc; its history e.g. whether the vehicle is single owner, multi-owner, was it a previous daily rental, the region where the vehicle was driven etc. any major or minor recalls of the vehicle by the manufacturer may be used amongst other things. Such data may be acquired from third parties by querying their online databases using the VIN of the vehicle being assessed.

This list is exemplary and is not indented to be exhaustive. One such method and system for automatic assessment of vehicle value is disclosed in a patent application titled “System and Method of Vehicle Value Assessment”, U.S. Ser. No. 14/728,542, filed on Jun. 2, 2015, the contents of which are incorporated herein by reference.

The difference is calculated between AV (assessed value) and PP (price paid) by the buyer (AV−PP) 703.

The difference is compared between AV and PP (AV−PP) with RE (Repair Estimate) 704.

The system checks whether (AV−PP) is larger than RE 705. If Yes 705a, (AV−PP) is larger than RE (repair estimate), then it is possible that there is no dispute 706. As an example if the difference between the assessed value (AV) and the price paid (PP) by the buyer (AV−PP) is greater than the RE (repair estimate) of the disputed feature(s) of the said vehicle then it is possible that there is no dispute as the lower price paid by the buyer takes into consideration the broken or faulty status of the disputed feature. For example if the buyer paid $1000 less than the assessed value (AV) and disputes that the tires are worn out, then if the tires can be replaced for $600, it is safe to say that the lower price paid by the buyer takes into consideration the worn out state of the tires.

The buyer may be informed that there is no dispute 707. For example, the buyer may be informed that there is no dispute using a communications means that is preferred by the buyer e.g. text message or e-mail.

If No 705b, (AV−PP) is not larger than RE (repair estimate), then there is a possibility that there is a dispute 708. As an example if the difference between assessed value (AV) and the price paid (PP) by the buyer is smaller than RE (repair estimate) of the disputed feature(s) of the said vehicle then it is possible that there is a dispute as the buyer paid more for the vehicle and the higher price does not take into consideration the discount due to the broken or faulty status of the disputed feature. For example if the buyer paid $500 more than the assessed value (AV) and disputes that the windscreen is cracked, then it is safe to say that the higher price paid does not take into consideration the cracked state of the windscreen and that the buyer is justified in initiating arbitration and wanting to have the windscreen replaced.

The seller may be informed that there is a dispute, and information may be provided regarding the vehicle and the disputed feature(s) 709. In one embodiment the seller is informed that there is a dispute using a communications means that is preferred by the seller e.g. text message or e-mail. The process is initiated for calculating the arbitration refund 710.

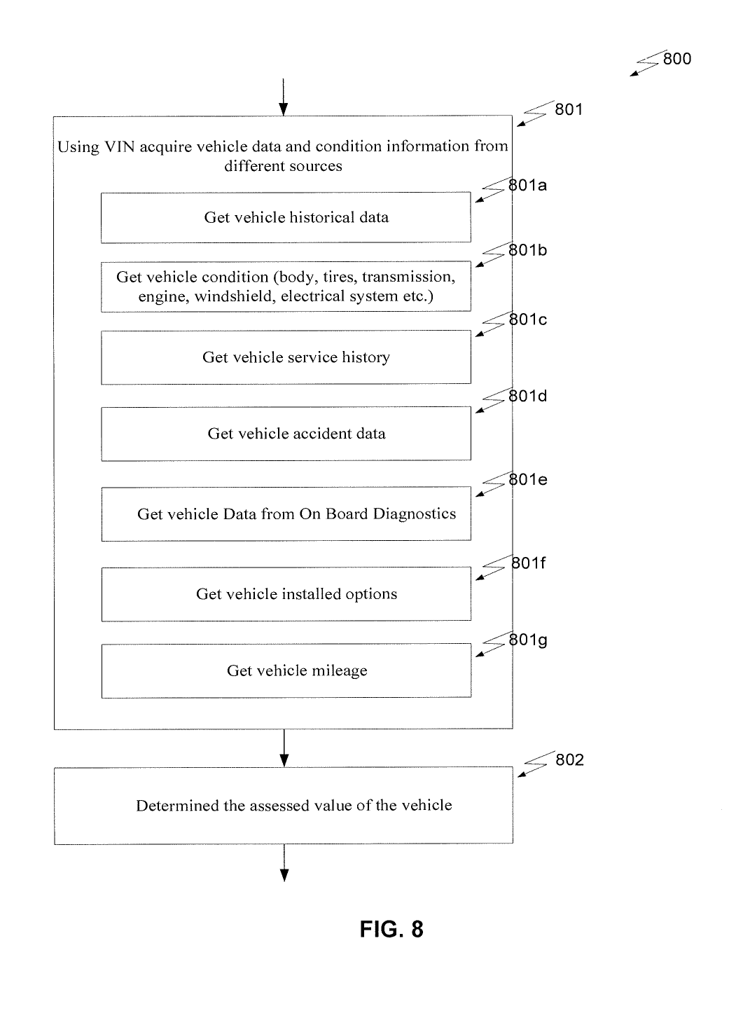

FIG. 8 shows one embodiment. Using VIN, vehicle data and condition information is acquired from different sources 801. For example, this information may be acquired by performing a VIN scan using a mechanised method to automatically machine read the VIN from the vehicle. Typically, the VIN is stamped into a plate that's mounted on the dashboard near the windshield or on the driver-side door jamb. It is also typically stamped on the engine's firewall.

The VIN may be inputted by the buyer by physically reading it from the vehicle. Such an embodiment may provide a user interface for inputting the VIN. User input may be provided via text or voice or other methods. In another embodiment there may be a Smartphone based app that can capture the VIN from a vehicle and transmit it to the server for processing. In yet another embodiment the VIN may be optically read with barcode scanners or digital cameras, or digitally read via OBD-II (On Board Diagnostics) which is available in some vehicles.

The information that is contained in the VIN may be decoded. VIN decode, or VIN explosion reveals the information that is encoded in a VIN. The VIN can reveal a number of things about a car, including its airbag type, country of origin, engine size, model year and trim level. This information may be used to get further information about the vehicle from third parties. VIN can be decoded using third party services.

Some information about a vehicle may not be available from the VIN, e.g. color, engine size, installed options. Such information may be obtained from third parties by querying their databases by supplying the VIN and getting this information.

The VIN may also be used to acquire information about the vehicle from internal resources e.g. data saved to a server.

In one embodiment the system sends the VIN and other vehicle identification information to different third party sources to acquire more detailed information about the vehicle.

Such detailed information may include vehicle historical data 801a. For example, the system may get/acquire vehicle history data from third parties. Examples of such third parties from vehicle history data may be acquired are Carproof, Experian (Autocheck) and CarFax. Such third parties may provide vehicle history data that may include but is not limited to registration, accidents, liens, title (rebuilt, stolen, flooded).

Such detailed information may also include vehicle condition (body, tires, transmission, engine, windshield, electrical system etc.) 801b. For example, the system may acquire vehicle condition data from automatic sources e.g. from On Board Diagnostics (OBD). Alternatively in another embodiment vehicle condition data may be acquired using image/photo analysis of multimedia of the vehicle. In yet another embodiment the condition data may be user provided such that there is an app that helps a user capture such information by using a wizard to step a person from one element to the next.

Such detailed information may also include vehicle service history 801c. For example, the system may get/acquire vehicle service history from third parties. It is well known that major repairs to vehicle may reduce its assessed value, while normal maintenance performed at prescribed intervals such as oil changes, tune ups and replacement of belts and hoses etc. contributes positively in the assessment of the value of a vehicle. Examples of such third parties from vehicle service history may be acquired are dealerships, authorised repair workshops, etc.

The system may also get vehicle accident data 801d, e.g. accident data from third parties. Examples of such third parties from vehicle accident data may be acquired are Carproof, Experian (Autocheck) and CarFax.

The system may also get vehicle data from On Board Diagnostics 801e. Such data may be obtained from a vehicle by plugging devices to the standard On Board Diagnostics ports that are available in most newer vehicles.

The system may also get vehicle installed options 801f, e.g. vehicle installed options information from third parties. Examples of such third parties from where vehicle installed options information may be acquired are dealerships, authorised repair workshops, etc. In another embodiment information about vehicle installed option may be provided by a user.

The system may also get vehicle mileage 801g. This may be acquired from On Board Diagnostics (OBD). Alternatively in another embodiment vehicle mileage data may be acquired by using image/photo analysis of odometer. In yet another embodiment the vehicle mileage may be user provided.

Different information items may be acquired from third parties by using the VIN. Several examples have been provided above but the invention is not limited to these examples but the intent is to cover all such information that may be acquired using the VIN.

The assessed value of the vehicle may be determined 802. In one embodiment the assessed value of the vehicle is determined and stored in a database.

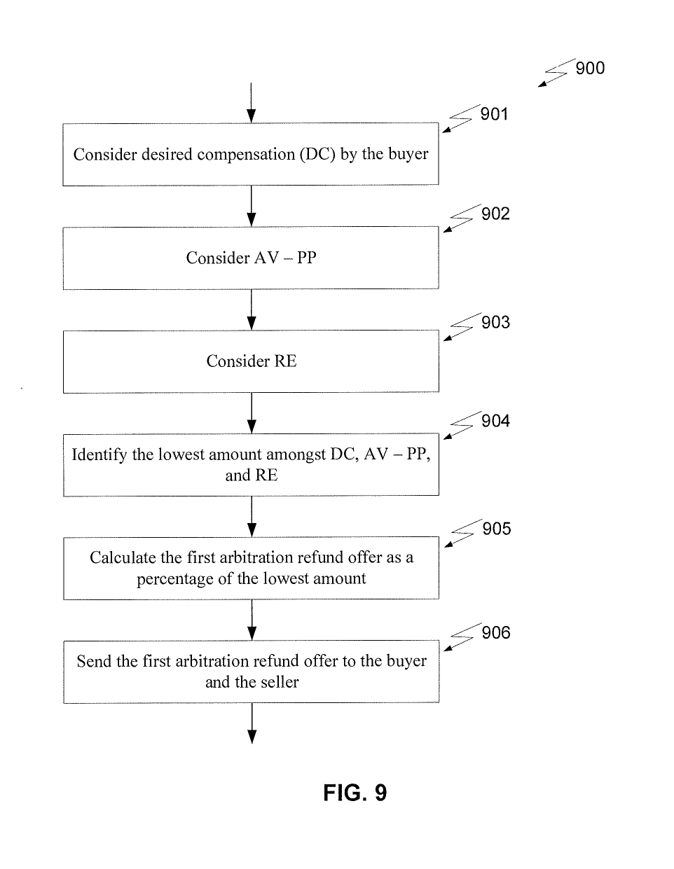

FIG. 9 shows one embodiment 900. The desired compensation (DC) by the buyer is considered 901.

AV (assessed value)−PP (Price Paid) is also considered 902. The system may calculate the difference between the assessed value of the vehicle and the price paid by the buyer for the said vehicle.

RE (Repair Estimates) is also considered 903. The repair estimates may be acquired from the historical data that is stored in the system. In another embodiment the repair estimates may be submitted by the buyer by having a repair shop provide a formal estimate to repair or replace the disputed feature(s). In yet another embodiment both the historical data and buyer provide data may be used together.

The system may identify the lowest amount amongst DC (desired compensation), (AV−PP) and RE (repair estimate) 904. In one embodiment the lowest amount can be determined by simply putting these three values in an ascending order and the first value then being identified as the lowest.

The first arbitration refund offer can be calculated as a percentage of the lowest amount 905. For example, the first offer may be a percentage, for example 85%, of the lowest value.

The first arbitration refund offer may be sent to the buyer and the seller 906. In one embodiment the system may send the first arbitration refund offer to the buyer and the seller via the app. Alternatively the first arbitration refund offer may be sent to the buyer and the seller via e-mail, voicemail, postal mail, or any other communications method that may be preferred by the users e.g. text message or instant message.

In one embodiment if the buyer does not accept the first arbitration refund offer, the system may automatically calculate and provide a second arbitration refund offer that is higher than the first arbitration refund offer (e.g. 100% rather than 85%). The system may continue this process until either the buyer accepts an arbitration refund offer or if the arbitration refund offer exceeds a threshold amount or cap (e.g. an upper limit), provide a last and final offer with an expiry time to accept the offer. Alternatively, the offers may be structured to start with the highest (or some other average or percentile) offer first, and then descend (in order to encourage quick settlement between the parties).

In one embodiment the arbitration refund or the arbitration refund offer may be displayed to the user via a user interface e.g. using a graphical user interface that may be part of the app. The arbitration refund or the arbitration refund offer may be displayed using a currency of the country or location where the vehicle is being disputed or arbitrated. For example in the US the amount may be displayed in US dollars, while in EU in Euros.

In one embodiment, there may be a time limit after which the arbitration refund or arbitration refund offer for a disputed feature of a vehicle may expire e.g. the arbitration refund offer is valid for 30 days. Preferably this time limit may be configurable. Preferably the expiry time may also be configurable and based on the other factors e.g. market volatility. Thus if repair/replacement costs are changing rapidly, then the arbitration refund may have a shorter shelf life. Such time limits may also be tailored to address legal requirements of a particular jurisdiction, or the preferences of the auction host or the parties to the transaction.

Preferably the historical data is stored in the system and accumulates over time as more data about the values of vehicles is accumulated. Alternatively such data may also be acquired from third parties in bulk and then refreshed from time to time as needed.

The system may also provide a notification service. The notification service may provide a notification to a buyer who had asked for a refund. The notifications/reminders from the notification service may be presented to the user via in-app messaging, e-mail, text message, phone call, voicemail, or via social networks e.g. Facebook page, Google+, Twitter etc. by preferably adding a link on the homepage of a bidder/seller on a social media website e.g. Facebook homepage. The notification service of the system may also provide periodic reminders.

These descriptions exemplify only some of the several possible embodiments and are not meant to be exhaustive. The intent is to cover all such possibilities and combinations that are obvious to the ones skilled in the art.

It should be understood that although the term application has been used as an example in this disclosure but in essence the term may also imply to any other piece of software code where the embodiments are incorporated. The software application can be implemented in a standalone configuration or in combination with other software programs and is not limited to any particular operating system or programming paradigm described here.

The computer program comprises: a computer usable medium having computer usable program code, the computer usable program code comprises: computer usable program code for presenting graphically to the users options for scrolling via the touch-screen interface.

The examples noted here are only for illustrative purposes and there may be further implementation embodiments possible with a different set of components. While several embodiments are described, there is no intent to limit the disclosure to the embodiment or embodiments disclosed herein. On the contrary, the intent is to cover any practical alternatives, modifications, and equivalents.

1. A method of computer-mediated arbitration following an online auction of a vehicle between a seller and a buyer, the seller and the buyer having consented to automatic arbitration of disputes related to the auction, the buyer having received and inspected the vehicle following the auction, the method comprising:
receiving or retrieving a vehicle identification number of the vehicle;
receiving or retrieving a price paid in the auction;
receiving a report of a disputed feature from the buyer, including a descriptive component and a photo or video component;
receiving from the buyer a desired compensation;
making a threshold assessment from the report as to whether a dispute is present, communicating with the seller if a dispute is present, and taking steps comprising:
receiving or retrieving an assessment of a vehicle value based on the vehicle identification number;
using the report to calculate or look up an estimate to repair or replace the disputed feature;
selecting a lowest one of the following values and from the selected lowest value, calculating a first settlement amount: the buyer's desired compensation, (the assessed vehicle value less the price paid), and the repair estimate; and
communicating the first settlement amount to the buyer; and
if the first settlement amount is accepted by the buyer, communicating the settlement to the seller, and automatically initiating funds settlement at the seller's and buyer's auction accounts.

2. The method of claim 1, wherein the first settlement amount is a percentage of the selected value.

3. The method of claim 1, wherein the repair estimate is an estimated or actual cost to repair or replace the disputed feature of the vehicle.

4. The method of claim 3, wherein the repair estimate is derived from at least one of realtime repair transactional data, industry accepted repair estimates, crowdsourced repair data, or repair estimate submitted by the buyer.

5. The method of claim 1, wherein the vehicle identification number is entered using at least one of a barcode scanner, digital camera, on board diagnostics, or user input.

6. The method of claim 1, wherein the vehicle value assessment is done using data retrieved by querying the vehicle identification number in a third party database.

7. The method of claim 1, wherein the vehicle value assessment is retrieved from an assessment done during or before the auction.

8. The method of claim 1, wherein the vehicle identification number and the price paid are retrieved from the auction.

9. The method of claim 1, wherein the first settlement offer has an expiry date or time.

10. The method of claim 1, further comprising if the first settlement offer is not accepted or expires, communicating a second settlement offer to the buyer.

11. The method of claim 10, wherein the step is repeated until an offer is accepted, or a threshold offer amount is reached, or a maximum time has elapsed.

12. The method of claim 1, wherein the threshold assessment includes an assessment of past auction or dispute behaviour or a ranking or a rating of at least one of the buyer and the seller.

13. The method of claim 1, wherein the vehicle value assessment comprises:
retrieving a universe of historical pricing data of vehicles having a common at least one parameter with the vehicle, and from the universe of historical pricing data, establishing a maximum potential wholesale value;
retrieving data regarding the vehicle and its condition and converting the data into at least one modifier; and
reducing the maximum potential wholesale value by the at least one modifier.

14. The method of claim 13, wherein retrieving data regarding the vehicle and its condition includes exploding the vehicle identification number using at least one third party database.

15. The method of claim 1, wherein the descriptive component of the report is submitted using text, voice, or another verbal medium.

16. The method of claim 1, wherein the threshold assessment occurs after the selecting step but before the communicating step.
